(19) United States
(12) Patent Application Publication
(10) Pub. No.: US 2015/0116395 A1
(43) Pub. Date: Apr. 30, 2015

(54) PRINTER AUTOMATICALLY VARYING PRINTHEAD TO PAPER PATH SPACING

(71) Applicant: Mark Andy, Inc., Chesterfield, MO (US)

(72) Inventor: Thomas Dayton Schelmbauer, Wildwood, MO (US)

(21) Appl. No.: 14/519,986

(22) Filed: Oct. 21, 2014

Related U.S. Application Data
(60) Provisional application No. 61/893,779, filed on Oct. 21, 2013.

(51) Int. Cl. B41J 25/308

(52) U.S. Cl. CPC B41J 25/308
USPC 347/8

(57) ABSTRACT

A printing system includes a media transport system that transports a web of print media in a media transport direction along a media path including through a print zone. A printhead having faces print zone, defining a spacing between the printhead and the media path. A positioning apparatus is configured to increase the spacing in response to receiving a signal indicative of a potential paper crash.

### CROSS-REFERENCE TO RELATED APPLICATIONS

This application claims priority to U.S. Provisional Patent Application Ser. No. 61/893,779 filed Oct. 21, 2013. The entire disclosure of the above application is incorporated herein by reference.

### FIELD OF THE INVENTION

The present invention relates to a digital commercial or industrial printing system utilizing printheads to form images upon a web of print media. More particularly the present invention relates to a subsystem that enables the printing system to avoid crashes between the media web and the printheads.

### BACKGROUND

A rapid change is occurring in the commercial and industrial printing marketplace with an expanded use of digital printing presses to replace their analog counterparts. Digital printing presses have an advantage of lower “set-up” costs in that a change to a print pattern is accomplished with a file change. This improves the economics of “short run” printing and reducing a need to print large inventories of a given design.

One common form of digital printing press is a web press based upon inkjet printing. In this embodiment a roll of media is unwound and then passed through a paper path defined by a series of rollers. A part of the paper path is a print zone within which inkjet printheads eject a dot matrix pattern of fluid drops on a surface of the media thereby forming images and/or text on the media surface.

An important aspect of inkjet printing is the spacing between the drop ejector face of the printhead and the surface of the print media. Minimizing the spacing improves print quality because drop trajectory errors between the drop ejector face and the print media are reduced. Such drop trajectory errors can arise from a number of sources such as air currents, tiny ejector defects, or surface tension of ink that may affect the way drops separate from the ejector face. Thus a small spacing is advantageous.

However this reduced spacing may put the printhead at risk. The media web can be traveling past the printhead at speeds of 400 feet per minute or more. If the media web impacts the printhead—known as a “paper crash”—then substantial damage to the printhead may occur. This is particularly an issue when a media splice passes through the printer.

### BRIEF DESCRIPTION OF THE DRAWINGS

FIG. 1 is an isometric view of an exemplary printing system.

FIG. 2 is a side view of an exemplary printing system.

FIG. 3 is a flow chart representation of an operation of a printing system.

Corresponding reference numerals indicate corresponding parts throughout the several views of the drawings.

### DETAILED DESCRIPTION

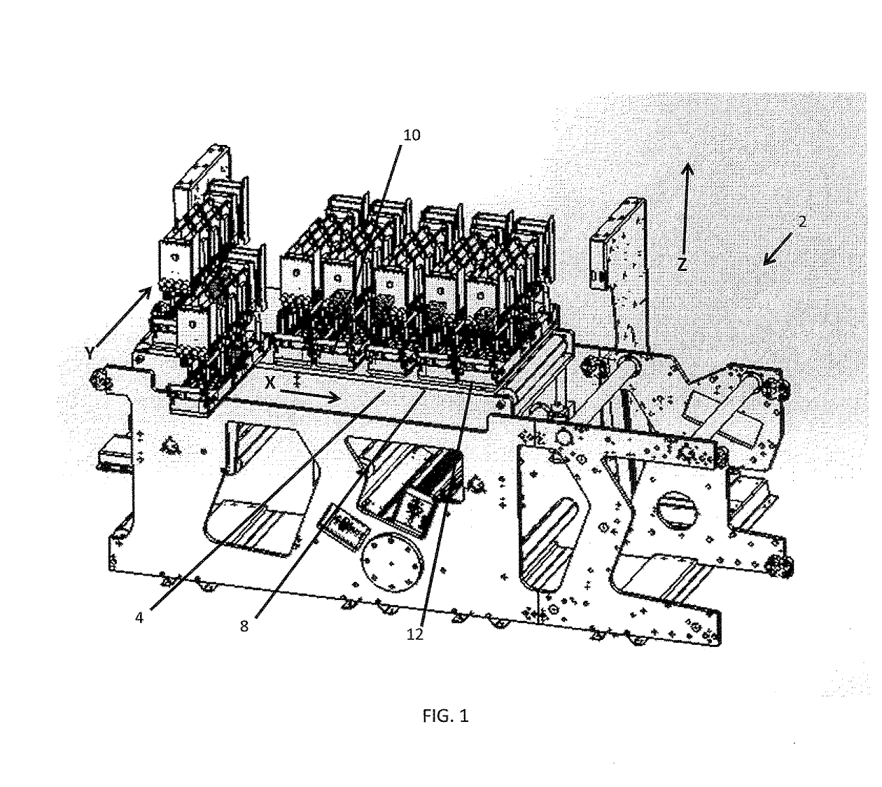

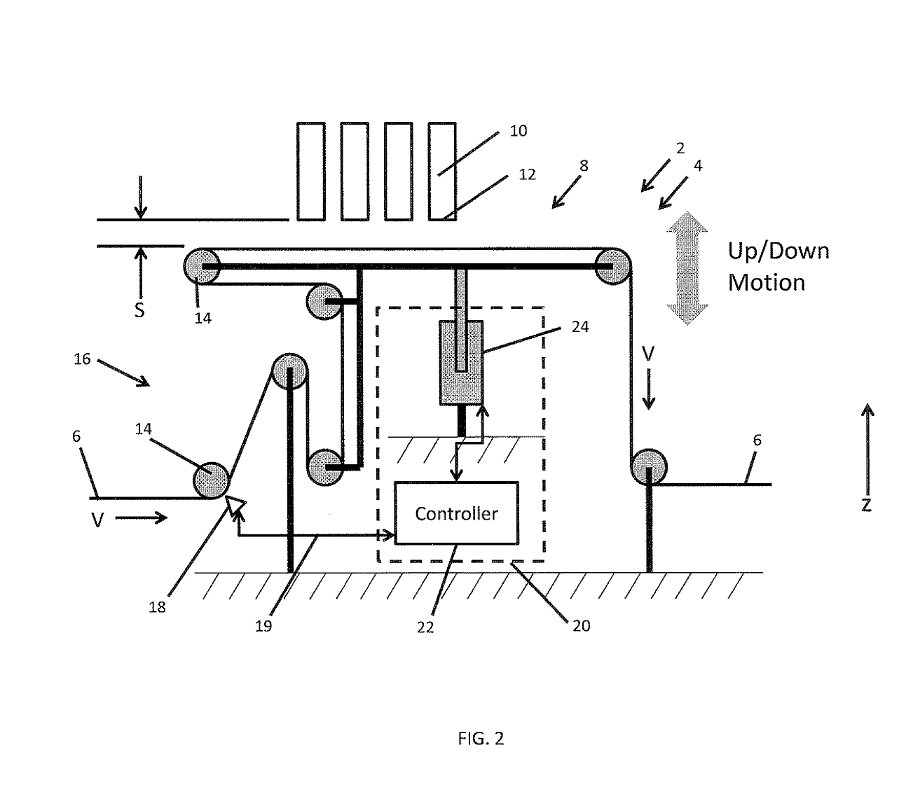

An exemplary embodiment of a printing system is indicated generally as 2 in FIG. 1. The printing system 2 includes a media transport system 4 configured to transport a web of print media 6 (see FIG. 2) from a source, such as a roll of print media (not shown), and through a print zone 8. Within print zone 8 printheads 10 operate to eject drops of ink on media 6 in a dot matrix form to form text and images on an upper surface of media 6.

Within print zone 8 the media is transported in a direction X. The printheads 10 span print the media along a transverse or cross-web direction Y. Each printhead 10 ejects droplets upon the media along a vertical axis Z from a lower portion or surface 12 of the printhead 10. The distance between surface 12 and the print media 6 is defined as a spacing S (see FIG. 2). This is a very important distance because as S becomes larger a drop trajectory error between surface 12 and print media 6 increases.

At the same time a very small distance S will make the printing system 6 susceptible to “paper crashes” whereby the paper impacts printhead 10 during print transport. This can be very damaging since printing system 2 may be configured to transport the print media at a high speed. An exemplary speed of transport is 400 feet per minute. Therefore spacing S tends to be controlled at a value of about 1 millimeter in order to avoid crashes while allowing for high print quality. Even with a 1 millimeter spacing S there can be crashes under certain events such as the passing of a paper splice through the paper path.

FIG. 2 is a simplified side view of printing system 2. The media transport system 4 includes a series of rollers 14 that define a circuitous media path 16 along which media 6 is transported. The media path 16 is referred to as circuitous because it changes in direction relative to the fixed axes X and Z referred to with respect to FIG. 1. The media transport direction V therefore varies relative to X and Z along media path 16. A “down-web” direction (+V) is defined as the direction the media is transported between a supply roll (not shown) and through the print zone 8. An “up-web” direction (−V) is the opposite of the “down-web” direction.

Positioned at a first position along the media path 16 is a sensor 18 that is configured to detect a potential source of a crash between media 6 and the lower surface 12 of printheads 10. In an exemplary embodiment, the sensor 18 is configured to detect a splice in the media 6. In the exemplary embodiment the sensor 18 is an optical emitter-detector pair. The emitter-detector pair “captures” a portion of the media web—in other words, the beam between the emitter and detector is partly intersected by the cross section of the print media thereby producing a detection signal that varies according to the thickness of paper passing the sensor. The sensor 18 is configured to generate a signal 19 in response to detecting a potential source of a crash such as a media splice.

Other types of sensors can also be used. In one alternative embodiment the sensor 18 can be a camera that captures a high speed video image of the edge of the media. In another alternative embodiment, the sensor 18 can be a mechanical finger that rests against the media surface. Motion of the finger is sensed that would be indicative of a sudden change in paper thickness.

The print zone 8 is down-web (+V) with respect to sensor 18. The down-web distance along the media path 16 allows time for printing system 2 to respond to a potential obstruction.

The spacing S between the printhead lower surface 12 and the media 6 is controlled by a positioning apparatus 20. The positioning apparatus 20 includes an actuator 22 that is under the control of controller 24. According to the illustrated embodiment, the positioning apparatus 20 is configured to raise or lower certain rollers 14 and other portions of media transport system 4. The positioning apparatus 20 is responsive to the signal 19 from the sensor 18. In response to receiving a signal 19 that is indicative of a splice in the media web 6, the positioning apparatus is configured to lower the paper path 16 in the print zone 8 in order to increase spacing S.

In an alternative embodiment, the positioning apparatus 20 is configured to raise the printheads 10 in order to increase the spacing S. In yet another alternative embodiment, the positioning apparatus is configured to raise the printheads 10 and to lower the media path 8.

The controller 24 is configured to automatically respond to the signal 19 from the sensor 18. The controller 24 may also respond to other signals from other parts of printing system 2 and adjust the spacing S in response. In an exemplary embodiment, the controller 22 is configured to define three values for spacing S including S1, S2, and S3. The value S1 is the spacing S that is used during a normal printing operation. In an exemplary embodiment, S1 is about 1 millimeter. In various embodiments S1 may take on other values between about 0.3 and 2.0 millimeters, depending upon the print media 6 being used and requirements for fine resolution.

The value S2 is a spacing S to avoid a potential crash such as avoiding a paper splice. Controller 24 controls actuator 22 to change the spacing from S1 to S2 in response to the detection of a paper splice. The value of S2 can be about 10 millimeters. In various embodiments the value S2 can take on values between 2 and 20 millimeters to avoid a paper crash. In one embodiment S2 is at least two times S1. In other embodiments S2 may be more than 2 to 20 times the value of S1.

The value S3 is a spacing S that enables servicing of the printheads 10. The controller 24 controls the actuator 24 to change the spacing to S3 in response to a signal indicative of a need to service printheads 10. The value of S3 can be about 150 millimeters. In various other embodiments S3 can take on values at or above 25 millimeters, 50 millimeters, or 100 millimeters. In one preferred embodiment S3 is at least 20 times S1. In still other embodiments the value of S3 can take on values that are between 20 and 500 times S1.

In one embodiment the actuator 24 is a three position piston allowing for spacing S values of S1, S2, and S3. In another embodiment the actuator 24 is a cam that pushes the print zone upward to either discrete or even a continuous range of spacing S values.

Between the sensor 18 and the first printhead 10 of print zone 8 is a certain paper path length referred to as “delta V”. This length is a parametric length due to the circuitous route of the paper—it would be the length of paper if the paper was taken out of the press, stretched out, and measured along the web length. The paper has a certain paper speed Q. Thus when a splice is detected there is a time T equal to delta V divided by Q during which positioning apparatus 20 needs to respond. According to the illustrated embodiment the positioning apparatus is configured to respond and to change S from S1 to S2 in a time TR that is less than T in response to receiving signal 18. According to the illustrated embodiment TR is less than T for the maximum value of Q for printing system 2 during which printing may take place.

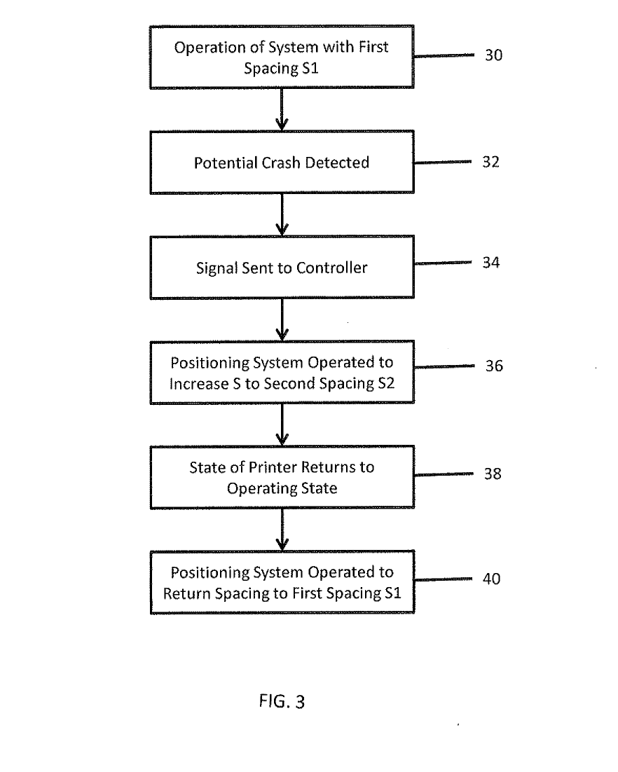

FIG. 3 shows a method for operating printing system 2. According to step 30, the printing system 2 is transporting media web 6 while spacing S equals S1. At step 30, printing can be taking place whereby printheads 10 are forming images and/or text on media web 6. During printing the spacing S1 may be about one millimeter.

At step 32 the sensor 18 detects a source of a potential paper crash such as a splice in media web 6. At step 34 the sensor 18 sends a signal 19 to the positioning system 20. At step 36, in response to receiving the signal, the positioning system 20 increases the spacing S to S2 which is sufficient to avoid a paper crash. The time TR between receiving the signal and changing S is less than the media transit time from the sensor 18 to the print zone 8.

At step 38 the printer returns to an operating state; that is, after the splice has passed the print zone 8. At step 40 the positioning system 20 returns the spacing S to the operating value of S1.

Further areas of applicability will become apparent from the description provided herein. The description and specific examples in this summary are intended for purposes of illustration only and are not intended to limit the scope of the present disclosure.

What we claim is:

1. A printing system comprising:
a media transport system configured to transport a web of print media in a media transport direction along a media path, the media path including a print zone;
a printhead having a lower surface facing the print zone whereby a spacing is defined between the lower surface and the media path;
a positioning apparatus configured to increase the spacing in response to receiving a signal indicative of a potential paper crash.

2. The printing system of claim 1 further comprising a sensor positioned along the media path at an up-web position to the print zone, the sensor configured to generate the signal in response to sensing a splice in the media web.

3. The printing system of claim 2 wherein the sensor is an optical sensor including an emitter detector pair that captures a portion of the media web.

4. The printing system of claim 2 wherein:
the media has a transport speed equal to Q;
a paper path length between the sensed portion of the media web and the print zone is equal to delta V; and
the positioning apparatus is configured to increase the value of the spacing in a time that is less than delta V divided by Q after receiving the signal.

5. The printing system of claim 1 wherein the positioning apparatus includes an actuator configured to raise and lower the media path in the print zone.

6. The printing system of claim 1 wherein the positioning apparatus includes a controller coupled to an actuator, wherein the actuator is configured to vary the spacing, and wherein the controller is configured to define at least three different values of the spacing including:
S1 which equals a spacing during a printing operation;
S2 which equals a spacing to avoid the potential paper crash; and
S3 which equals a spacing to enable maintenance of the printheads.

7. A printing system comprising:
a media transport system configured to transport a web of print media in a media transport direction along a circuitous media path, the media path including a print zone;
a printhead having a lower surface facing the print zone whereby a spacing S is defined between the lower surface and the media path;
a positioning apparatus configured to vary the spacing in response to signals indicating a change in state of the printing system including the following values of spacing S including S1 which is a spacing for a printing operation, S2 which is greater than S1 and is a spacing in response to a sensed event and S3 which is greater than S2 and is a spacing to enable a printing system maintenance operation.
